(19) United States
(12) Patent Application Publication
(10) Pub. No.: US 2026/0243910 A1
(43) Pub. Date: Aug. 20, 2026

(54) CHARACTERIZATION METHOD FOR SAND BODY ARCHITECTURE BASED ON AMPLITUDE PROPERTIES OF SEISMIC TROUGHS AND PEAKS

(71) Applicant: Chengdu University of Technology, Chengdu (CN)

(72) Inventors: Xiaoju Zhang, Chengdu (CN); Bohan Duan, Chengdu (CN); Hucheng Deng, Chengdu (CN); Gang Chen, Yibin (CN); Yize Zhang, Chengdu (CN); Yiming Gou, Yibin (CN); Yang Yong, Chengdu (CN); Hongyun Li, Chengdu (CN); Shiyi Bai, Chengdu (CN)

(21) Appl. No.: 19/193,607

(22) Filed: Apr. 29, 2025

(30) Foreign Application Priority Data
Feb. 14, 2025 (CN) 202510162547.X

(51) Int. Cl. G01V 1/30

(52) U.S. Cl. CPC G01V 1/307

(57) ABSTRACT

Disclosed is a characterization method for sand body architecture based on the amplitude properties of seismic troughs and peaks, including the following steps that: firstly, 7 orders of architectural interfaces are divided; 8 types of architectural unit assemblages are divided, and the architectural unit assemblages are divided into 3 classes; the seismic attribute property parameters of troughs and peaks are selected to analyze seismic response differences of the 3 classes of architectural unit assemblages, seismic response patterns of different architectures are constructed, plane distribution properties of trough-peak ratios are defined, and seismic identification standards of the 3 classes of architectural unit assemblages are established; and finally, a plane distribution prediction of sand body architecture is completed. In the present disclosure, geological-seismic response identification standards with different architectures are constructed, and quantitative prediction of sand body architectures is carried out.

### CROSS-REFERENCE TO RELATED APPLICATION

This application claims priority of Chinese Patent Application No. 202510162547.X, filed on Feb. 14, 2025, the entire contents of which are incorporated herein by reference.

### TECHNICAL FIELD

The present disclosure relates to the technical field of oil and gas exploration, and in particular to a characterization method for sand body architecture based on the amplitude properties of seismic troughs and peaks.

### BACKGROUND

As an unconventional gas reservoir, tight sandstone gas has great resource prospects in the world. The total reserves and annual total production of China's tight sandstone gas fields have accounted for about ⅓ and ¼ of China's total natural gas reserves and annual total production, and have become the most important and realistic source to replace conventional oil and gas resources in the next decade or two.

At present, a lot of research work has been carried out on the architecture of sand bodies, but the research basically adopts the conventional architecture research idea to carry out related research, mainly based on sedimentary microfacies, dividing the architectural units of different grades of single sand bodies, and analyzing the scale, shape, direction and superposition relationship of the architectural units. With the continuous advancement of tight gas reservoir exploration and development, the scale of tight sandstone gas enrichment and high production areas in the research area is limited, and the production and reserves of single wells in the same set of channel sand bodies are quite different. Mainly based on geological response properties, the research on sand body architecture distribution prediction has not been carried out quantitatively in assemblage with seismic response properties, which has not been able to guide well location deployment in the later exploration and development process.

The existing patent CN201910793343.0 provides a quantitative analysis method of sand body architecture, which mainly identifies a cycle interface in a research area, and determines a sand body architectural interface according to the cycle interface; analyzing the sand body architectural interface to obtain single well sand body architecture elements and contact relationships; combining the architecture elements and contact relationships of the single well sand bodies to obtain a longitudinal sand body splicing relationship; predicting a transverse sand body splicing relationship according to the longitudinal sand body splicing relationship; obtaining a plane distribution map of sand bodies according to the longitudinal sand body splicing relationship and the transverse sand body splicing relationship; and realizing the fine description of sand body shape and scale using Monte Carlo simulation and numerical simulation according to the plane distribution map of sand bodies. However, the existing patents adopt conventional architecture research ideas to carry out related research, mainly based on sedimentary microfacies, divide different grades of single sand body architectural units, and analyze the scale, shape, direction and superposition relationship of the architectural units. The shape and scale of sand bodies have not been described in assemblage with seismic response properties.

### SUMMARY

A main objective of the present disclosure is to solve the problem that the shape and scale of sand bodies have not been described in assemblage with seismic response properties in the related art.

In order to achieve the above objective, the present disclosure provides a characterization method for sand body architecture based on the amplitude properties of seismic troughs and peaks, including the following steps:
S1, dividing a research area into 8 types of architectural unit assemblages to characterize geological response properties thereof based on existing research results of sedimentary microfacies, and defining 3 classes of architectural unit assemblages in the research area;
S2, analyzing seismic response differences of the 3 classes of architectural unit assemblages based on seismic attribute property parameters of troughs and peaks, and constructing seismic response patterns of the 3 classes of architectural unit assemblages;
S3, defining the seismic response differences of the 3 classes of architectural unit assemblages according to an amplitude of seismic root mean square and ratios of troughs P2/peaks P3 based on an analysis of the seismic response properties and pattern construction, and determining seismic response identification standards of the 3 classes of architectural unit assemblages; and
S4, analyzing geological response properties of single well point sand body architecture, combining with seismic response identification standards of amplitudes of root mean square and ratios of troughs/peaks of sand bodies with different architectures to complete a plane distribution prediction of the sand body architecture.

Further, S1 specifically includes the following steps:
S11, defining 7 orders of architectural interfaces in the research area based on conventional architectural interface classification solutions, characterizing internal structures of single channels under the 7 orders of architectural interfaces, and defining 6 types of 5th-order single architectural units developed within single sand bodies of a target sand unit in the research area based on the existing research understanding of sedimentary microfacies;
S12, defining the 8 types of architectural unit assemblages according to the single architectural units and vertical assemblage sequence thereof; and
S13, dividing the 8 types of architectural unit assemblages into 3 classes according to a sand-to-ground ratio, the serration degrees of gamma ray (GR) curves and physical properties based on geological geometric parameter ranges of different architectural unit assemblages.

Further, the 7 orders of architectural interfaces in S11 are striate layer, micro bottom shape, moderate bottom shape, large bottom shape internal accretion body, large bottom shape, single channel and composite channel.

Further, the vertical assemblage sequence in S12 is to identify the 5th-order single architectural units by the sand body thickness, porosity and sedimentary microfacies properties, and analyze the assemblage properties of the 5th-order single architectural units in a vertical direction; and defining a vertical assemblage sequence.

Further, the 8 types of architectural unit assemblages in S12 are specifically: main channel sand+main channel sand, secondary channel sand+secondary channel sand, main channel sand+estuary bar sand, secondary channel sand+estuary bar sand, main channel sand+flood fan+natural dike, secondary channel sand+abandoned channel+flood fan+natural dike, estuary bar sand+secondary channel sand+abandoned channel, and secondary channel sand+abandoned channel.

Further, the specific embodiments in S13 are as follows:
performing cluster analysis on geological geometric parameters of different architectural unit assemblages using the statistical package for the social sciences (SPSS), simultaneously plotting cross-plots in pairs to obtain the geological geometric parameter ranges of different architectural unit assemblages, and dividing the 8 types of architectural unit assemblages in the 3 classes according to the sand-to-ground ratios, the serration degrees of the GR curves, and physical differences.

Further, the 3 classes of architecture unit assemblages are as follows: Class A architecture has a sand-to-ground ratio between 0.34 and 0.63, a serration index less than 12%, and a porosity between 9% and 11%; Class B architecture has a sand-to-ground ratio between 0.36 and 0.41, a serration index between 12% and 15%, and a porosity between 7% and 9%; and Class C architecture has a sand-to-ground ratio between 0.11 and 0.24, a serration index more than 15%, and a porosity between 3% and 6%.

Further, S2 specifically includes the following steps:
S21, taking response parameters of troughs and peaks as a basis for identifying different sand body types; and
S22, constructing the seismic response patterns of 3 classes of architectural unit assemblages based on the seismic response parameters of trough P2 and peak P3.

Further, the seismic response patterns of the 3 classes of architectural unit assemblages in S22 are specifically as follows: Class A is wide trough strong reflection, with a waveform P2≥P3; Class B is moderate-weak trough and moderate-weak peak reflection, P2≤P3; and Class C is strong peak reflection, P2<P3.

Further, the seismic response identification standards of the 3 classes of architectural unit assemblages in S3 are as follows: Class A peak is smaller than a trough, with a strong amplitude, and a trough/peak ratio is between 1 and 2; Class B peak is larger than a trough, with a moderate amplitude, and a trough/peak ratio is between 0 and 1; and Class C peak is larger than a trough, with a strong amplitude, and a trough/peak ratio is between 0 and 1.

### Advantageous Effects

The present disclosure provides a set of characterization technology for sand body architecture based on the amplitude properties of seismic troughs and peaks, which can evaluate the sand body architecture more efficiently and accurately. Previously, a prediction of sand body architecture distribution is carried out from a qualitative-semi-quantitative perspective based on the geological response properties, but the quantitative characterization of sand body architecture is not carried out in assemblage with the seismic response properties, which failed to guide well location deployment in the later exploration and development process. In the patent disclosure, mainly based on the geological response properties, combined with the seismic response properties including seismic troughs and peaks amplitude, the geological-seismic response identification standards of different architectures are constructed, and the quantitative prediction of sand body architecture is carried out, which not only provides a theoretical basis for the prediction of sand body architecture, but also has important guiding significance for the next exploration and development of tight sandstone gas.

### BRIEF DESCRIPTION OF THE DRAWINGS

FIG. 1 is a flowchart of a characterization method for sand body architecture provided by the present disclosure.

FIG. 2 is a 5th-order architectural unit property chart provided by the present disclosure;

FIG. 3 shows seismic response patterns of different types of sand bodies provided by the present disclosure;

FIG. 4 is a seismic reflection single well cross-sectional view of a J3 provided by the present disclosure;

FIG. 5 is a seismic reflection single well cross-sectional view of a well T1 provided by the present disclosure;

FIG. 6 is a single well seismic cross-sectional view of a well X1 provided by the present disclosure;

FIG. 7 is a diagram of seismic response properties and patterns of different architectures provided by the present disclosure;

FIG. 8 is a cross-plot of troughs and peaks amplitudes for different architectures provided by the present disclosure;

FIG. 9 is a trough/peak ratio share price chart of different architectures provided by the present disclosure;

FIG. 10 is a plane distribution diagram of channel troughs/peaks of No. 1 sand unit of Shaximiao Formation of a TF gas field provided by the present disclosure;

FIG. 11 is a plane distribution diagram of channel troughs/peaks of No. 2 sand unit of Shaximiao Formation of the TF gas field provided by the present disclosure;

FIG. 12 is a plane distribution diagram of sand body architecture of No. 1 sand unit of Shaximiao Formation of the TF gas field provided by the present disclosure; and

FIG. 13 is a plane distribution diagram of sand body architecture of No. 2 sand unit of Shaximiao Formation of the TF gas field provided by the present disclosure.

### DETAILED DESCRIPTION

In order to make the objects, technical solutions and advantages of the present disclosure more clear, the present disclosure will be further described in detail with examples. It is to be understood that the specific examples described herein are only used to explain the present disclosure and are not intended to limit the present disclosure.

The application principle of the present disclosure will be further described below with reference to the accompanying drawings and specific examples.

### Example 1

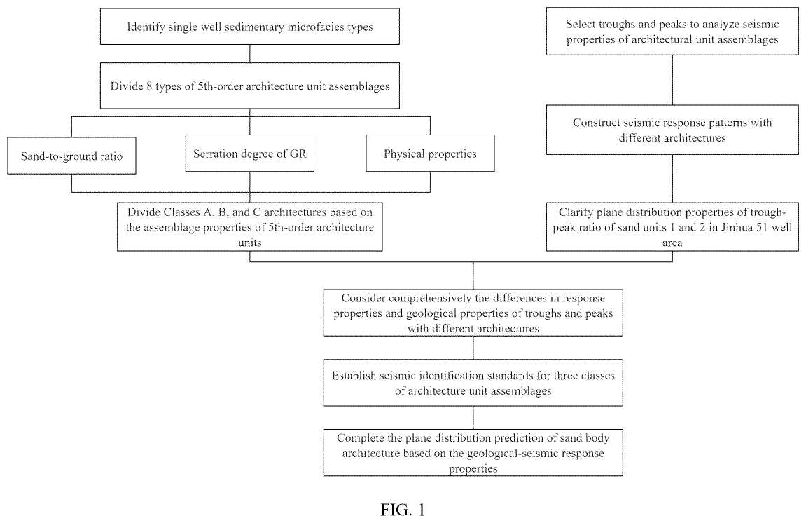

In this study, the channel sandstone of Shaximiao Formation in a TF gas field is taken as an object, and the sand body architecture research is carried out by means of well-log and seismic data. FIG. 1 is referred to for specific research ideas. Firstly, 7 orders of architectural interfaces are divided based on the existing research results of sedimentary microfacies. 8 types of architectural unit assemblages are divided according to a vertical assemblage sequence of a single architectural unit. The architectural unit assemblages are divided into 3 classes based on a sand-ground ratio, a serration degree of GR curve and physical properties. The seismic attribute property parameters of troughs and peaks are selected to analyze seismic response differences of the 3 classes of architectural unit assemblages, and seismic response patterns of different architectures are constructed; and plane distribution properties of trough-peak ratio of Shaximiao Formation in a TF gas field are defined, and a seismic root mean square amplitude and the trough-peak ratio are synthesized to establish seismic identification standards of the 3 classes of architectural unit assemblages. Finally, the plane distribution prediction of sand body architecture is completed based on geological-seismic response properties.

In, S1, the research area is divided into 3 classes of architectural unit assemblages based on the geological response properties of 8 types of architectural unit assemblages.

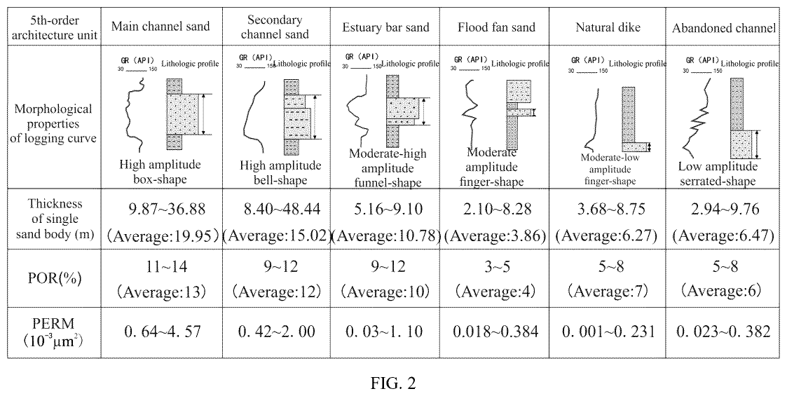

Based on conventional architectural interface classification solutions, 7 orders of architectural interfaces are defined in the research area, which are strata, micro-bottom shape (wave mark, inner accretion of sand dune), moderate-bottom shape (sand dune), large-bottom shape inner accretion (lateral accretion), large-bottom shape (point bar, flood fan and natural dike), single channel and compound channel. In this study, internal structures of single channels under the 7 orders of architectural interfaces are mainly described. 6 types of 5th-order of single architectural units developed within single sand bodies of a target sand unit in the research area are defined based on the existing research understanding of sedimentary microfacies, and the 6 types are main channel sand, secondary channel sand, estuary bar sand, flood fan sand, natural dike and abandoned channel. The shape of a GR curve of main channel is high amplitude box-shape, a thickness of single sand body is between 9.87 m and 36.88 m, a porosity is between 11% and 14%, and a permeability is between 0.64×10⁻³ μm² and 4.57×10⁻³ μm². The shape of a GR curve of secondary channel sand is high amplitude bell-shape, a thickness of single sand body is between 8.40 m and 48.84 m, a porosity is between 9% and 12%, and a permeability is between 0.42×10⁻³ μm² and 2.00×10⁻³ μm². The shape of a GR curve of estuary bar sand is moderate-high amplitude funnel-shape, a thickness of single sand body is between 5.16 m and 9.10 m, a porosity is between 9% and 12%, and a permeability is between 0.03×10⁻³ μm² and 1.10×10⁻³ μm². The shape of a GR curve of flood fan sand is moderate amplitude finger-shape, a thickness of single sand body is between 2.10 m and 8.28 m, a porosity is between 3% and 5%, and a permeability is between 0.018×10⁻³ μm² and 0.384×10⁻³ μm². The shape of a GR curve of natural dike is moderate-low amplitude finger-shape, a thickness of single sand body is between 3.68 m and 8.75 m, a porosity is between 5% and 8%, and a permeability is between 0.001×10⁻³ μm² and 0.231×10⁻³ μm². The shape of a GR curve of abandoned river channel is low amplitude serrated-shape, a thickness of single sand body is between 2.94 m and 9.76 m, a porosity is between 5% and 8%, and a permeability is between 0.023×10⁻³ μm² and 0.382×10⁻³ μm². The geological properties of different architectural units are clarified (FIG. 2).

According to the single architectural unit and the vertical assemblage sequence thereof, the 8 architectural unit assemblages are defined, including main channel sand+main channel sand, secondary channel sand+secondary channel sand, main channel sand+estuary bar sand, secondary channel sand+estuary bar sand, main channel sand+flood fan+natural dike, secondary channel sand+abandoned channel+flood fan+natural dike, estuary bar sand+secondary channel sand+abandoned channel, and secondary channel sand+abandoned channel. The vertical assemblage sequence mainly identifies the 5th-order of architectural units of a single well through properties of sand body thickness, porosity and sedimentary microfacies, and analyzes the assemblage properties of the 5th-order of architectural units in the vertical direction of a single well, thereby defining a vertical assemblage sequence.

The geological geometric parameters of different architectural unit assemblages are analyzed by SPSS, and the cross-plot is drawn in pairs to obtain the geological geometric parameters ranges of different architectural unit assemblages. According to sand-to-ground ratios, serration degrees of GR curves and property differences, the 8 types of architectural unit assemblages are further divided into 3 classes of architectural unit assemblages. Class A architecture has a sand-to-ground ratio between 0.34 and 0.63, a serration index less than 12%, and a porosity between 9% and 11%; Class B architecture has a sand-to-ground ratio between 0.36 and 0.41, a serration index between 12% and 15%, and a porosity between 7% and 9%; and Class C architecture has a sand-to-ground ratio between 0.11 and 0.24, a serration index more than 15%, and a porosity between 3% and 6%.

In S2, seismic response differences of 3 classes of architectural unit assemblages are analyzed based on the property parameters of troughs and peaks seismic attributes, and the seismic response patterns of different architectures are constructed.

In S21, response parameters of troughs and peaks are selected as the basis for identifying different sand body types.

According to the difference of sand bodies and different lithologies on the seismic reflection profile, thick sandstone with high porosity shows negative reflection on the top surface with a symmetrical waveform. Mudstone interbedded with high porosity sandstone shows positive reflection on the top surface with a symmetrical waveform. Basal mudstone interbedded with a high-velocity layer (h<λ/4) shows opposite polarities at top and base interfaces, generating a derivative-shaped wavelet with a right-dipping symmetrical waveform. Mudstone interbedded with tight sandstone (high-velocity layer) shows opposite polarities at top and base interfaces, generating a derivative-shaped wavelet with a left-dipping symmetrical waveform. Transitional layers with abrupt basal contacts and upward-decreasing velocities (h<λ/2) show integrated wavelets. Thin interbedded layers with abrupt top contacts and upward-increasing velocities (h<λ/2) show integrated wavelets, where, h represents a sand body thickness, and λ represents a wavelength. This technology mainly studies the seismic reflection waveform of mudstone interbedded with high-velocity sandstone and mudstone interbedded with high-velocity layer. The determination method of seismic reflection waveform is as follows: when the two-way travel time interval of two reflection interfaces is greater than one wavelet length, the reflection waves of these two interfaces have no interference and can be completely separated. When the two-way travel time interval is shorter than the wavelet length, interference will occur and a composite wave will be formed. When the wavelength is greater than λ/4, there is no superposition, but when the wavelength is smaller than λ/4, the wavelength is superimposed. With the smaller thickness, the interference causes the top-bottom reflection to cancel out, and the amplitude gradually weakens.

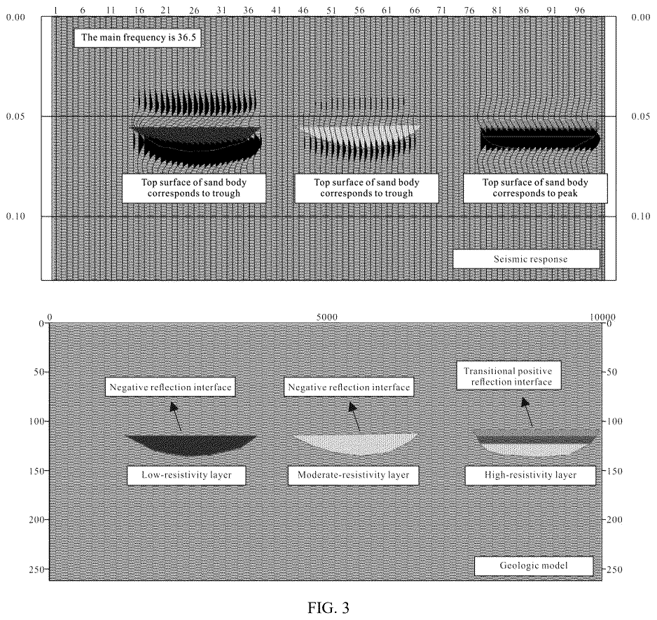

The wave impedance structure is mainly established by macroscopic layer division method. Macroscopic layer division is a layer or layer system with roughly the same wave impedance and plays a major role in seismic recording. There are obvious differences in wave impedance between macroscopic layers, and the internal wave impedance difference is relatively negligible. The high porosity and permeability in thick mudstone is the seismic response of sandstone bright spots, and the overall velocity of permeable sand layer is lower than that of mudstone, showing a low-velocity layer, with negative reflection at the top surface and positive reflection at the bottom surface, oblique symmetrical waveforms at the peak and trough, and a good correspondence between the sand layer group and the trough-peak (the top of the sand layer corresponds to the trough at the bottom). Within the overlying bell-shaped structure of the channel sand body, multiple positive reflections are generated. The side lobe troughs of these reflections interfere and superimpose onto the trough of the sand body top surface, resulting in trough amplification (FIG. 3, where the background color represents mudstone).

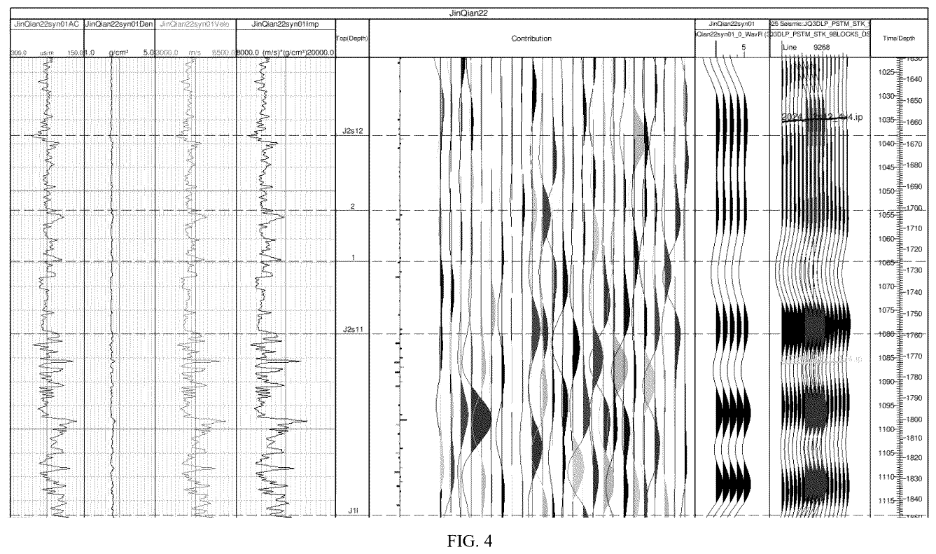

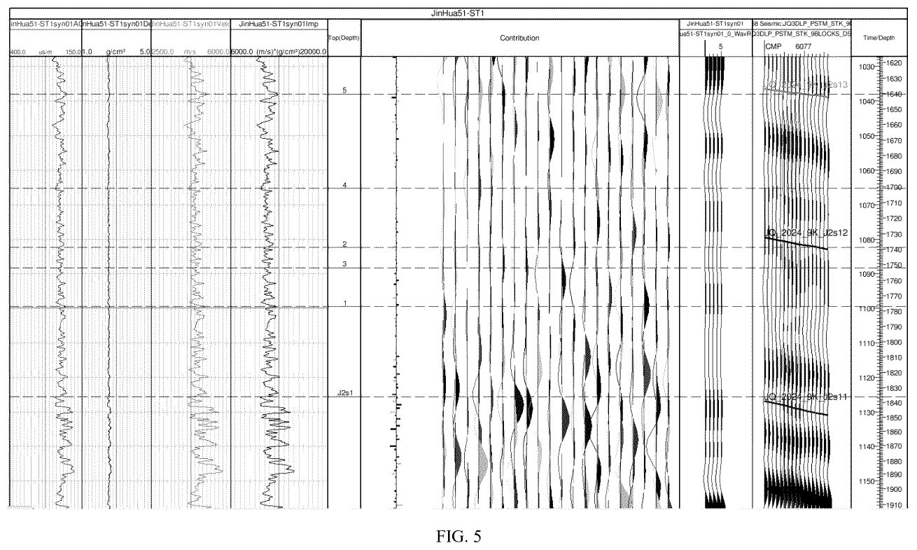

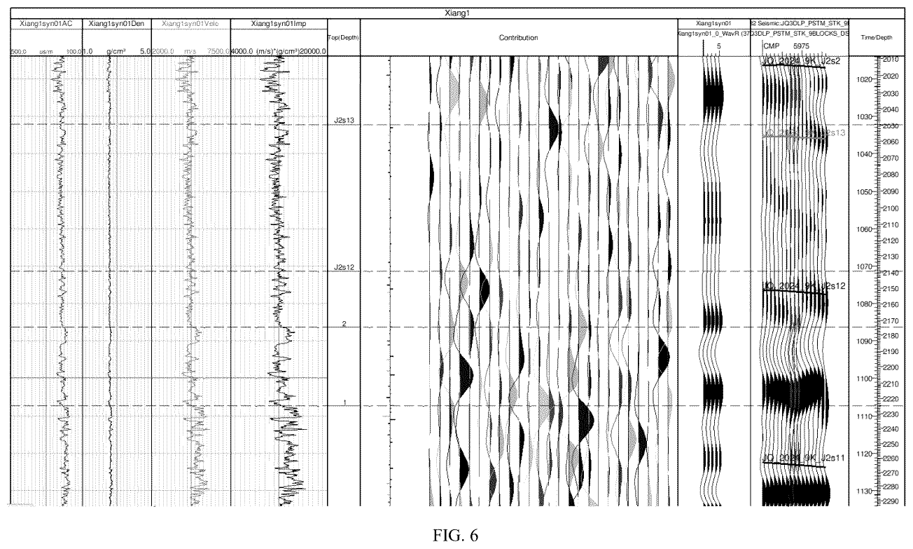

Taking the single well of Shaximiao Formation in the research area as an example, the side lobe trough of the overlying mudstone positive reflection interface is superimposed on the sandstone top surface of a well J3 to amplify the top trough, and the side lobe trough of the underlying mudstone positive reflection interface is superimposed on the bottom surface to weaken the bottom trough (FIG. 4). The velocity of overlying mudstone and sandstone in a well T1 is similar, the overall reflection amplitude is weak, and the top-bottom reflection amplitude is similar (FIG. 5). The overlying negative reflection side lobe peak of a well X1 is superimposed on the sandstone top reflection to amplify the sandstone top peak, and the underlying positive reflection peak is superimposed on the sandstone bottom reflection to weaken the sandstone bottom trough (FIG. 6).

In S22, seismic response patterns of sand bodies with different architectures are constructed.

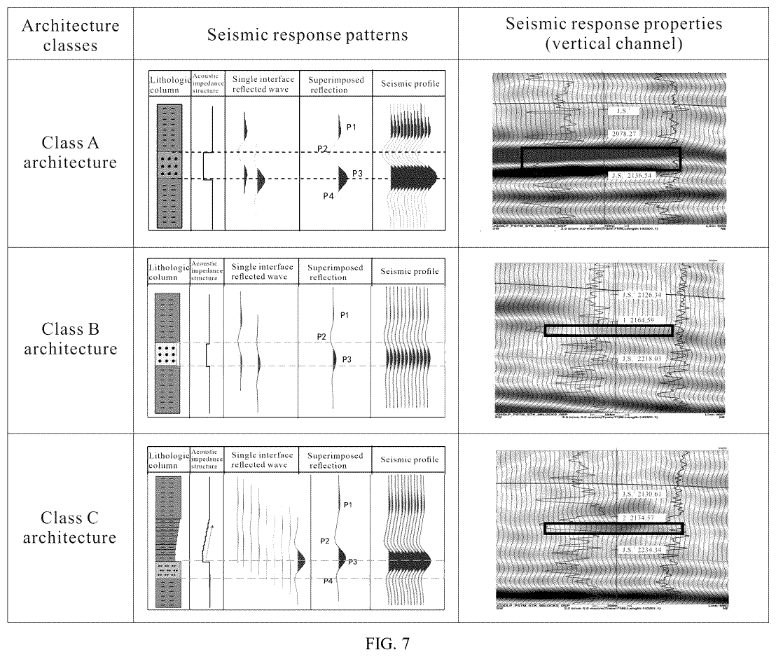

Based on the above analysis, the trough (P2) and the peak (P3) are selected as typical seismic response parameters for the quantitative prediction of sand body architecture, and the seismic response patterns of 3 classes of architectural unit assemblages are constructed, among which Class A is wide trough strong reflection, with a waveform P2>P3; Class B is moderate-weak trough and moderate-weak peak reflection, P2≤P3; and Class C is strong peak reflection, P2<P3 (FIG. 7).

In S3, the seismic response identification standards of 3 classes of architectural unit assemblages are established.

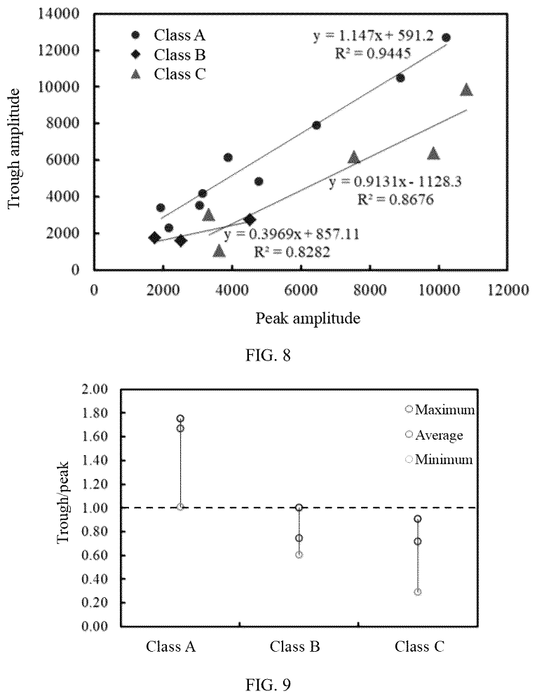

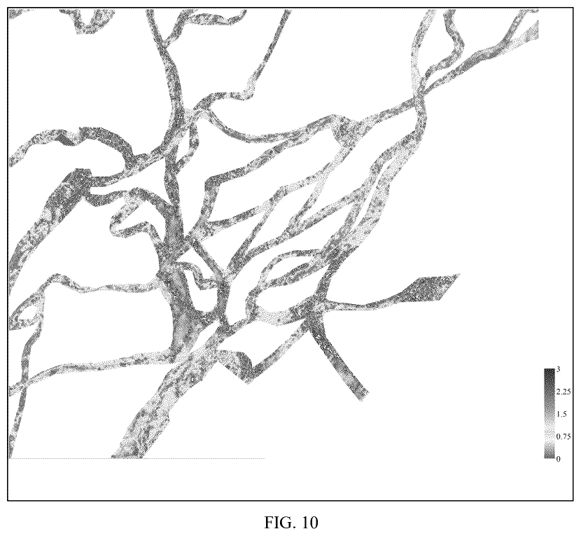

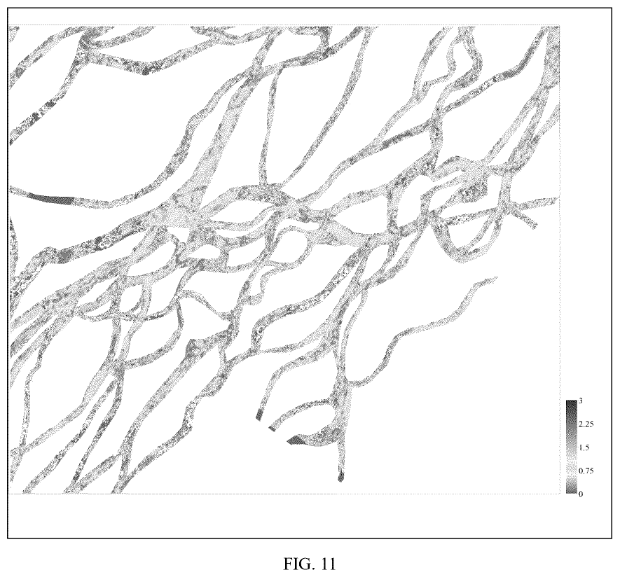

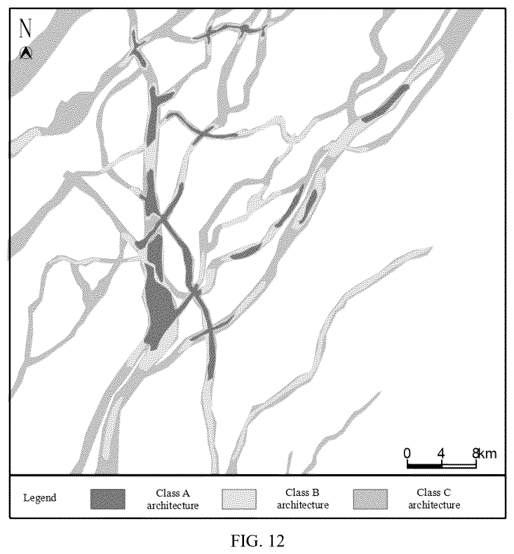

Based on the above analysis of seismic response properties and pattern construction, and based on statistical analysis, the seismic response properties of 3 classes of different architectures are clustered and analyzed. According to the amplitude of seismic root mean square and a ratio of trough (P2)/peak (P3), the seismic response differences of the 3 classes of architectural unit assemblages are further defined. A peak of Class A is smaller than a trough, an amplitude is strong, and a ratio of trough/peak is between 1 and 2. A peak of Class B is larger than a trough, with a moderate amplitude, and a trough/peak ratio is between 0 and 1. A peak of Class C is larger than a trough, with a strong amplitude, and a trough/peak ratio is between 0 and 1 (FIGS. 8-11).

In S4, a plane distribution prediction of sand body architecture is completed based on the geological-seismic response properties.

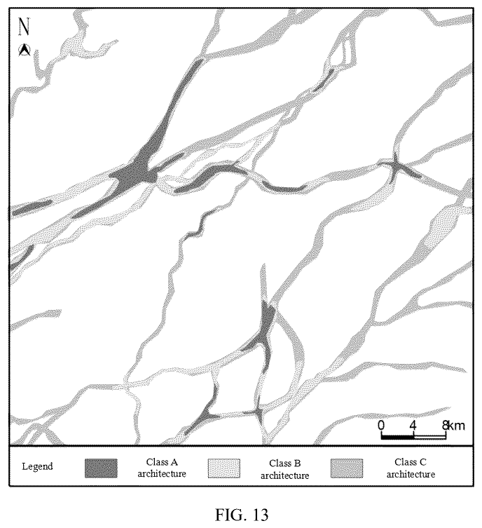

Through the analysis of geological response properties of single well point sand body architecture, combined with the seismic quantitative identification standards including root mean square amplitude and trough/peak ratio of sand bodies with different architectures, the sand body architecture distribution prediction of Shaximiao Formation in the research area is completed (FIG. 12 and FIG. 13), and a coincidence rate of well seismic identification is 94%.

Based on the above plane distribution prediction of sand body architecture, the prediction results of the well J1 and the well J2 in the research area are verified. A sand-to-ground ratio of the well J1 is 0.52, a serration index of GR curve is 8%, a porosity is 10%, and a ratio of trough to peak is 1.65. A sand-to-ground ratio of the well J2 is 0.61, a serration index of the GR curve is 3%, a porosity is 11%, and a ratio of trough to peak is 1.72. It is verified that the sand body architecture types of both wells are Class A, and the prediction results of sand body architecture are reliable. The plane distribution prediction of sand body architecture is completed based on the geological-seismic response properties.

All the above-mentioned are only the preferred examples of the present disclosure, and are not used to limit the scope of the present disclosure. Any modifications, equivalent replacements, and improvements made within the spirit and principle of the present disclosure are included in the protection scope of the present disclosure.

1. A characterization method for sand body architecture based on amplitude properties of seismic troughs and peaks, comprising:
S1, dividing a research area into 8 types of architectural unit assemblages to characterize geological response properties thereof based on existing research results of sedimentary microfacies, and defining 3 classes of architectural unit assemblages in the research area;
S2, analyzing seismic response differences of the 3 classes of architectural unit assemblages based on seismic attribute property parameters of troughs and peaks, and constructing seismic response patterns of the 3 classes of architectural unit assemblages;
S3, defining the seismic response differences of the 3 classes of architectural unit assemblages according to an amplitude of seismic root mean square and ratios of troughs P2/peaks P3 based on an analysis of the seismic response properties and pattern construction, and determining seismic response identification standards of the 3 classes of architectural unit assemblages; and
S4, analyzing geological response properties of single well point sand body architecture, combining with seismic response identification standards of amplitudes of root mean square and ratios of troughs/peaks of sand bodies with different architectures to complete a plane distribution prediction of the sand body architecture;
wherein the 3 classes of architectural unit assemblages are as follows: Class A architecture has a sand-to-ground ratio between 0.34 and 0.63, a serration index less than 12%, and a porosity between 9% and 11%; Class B architecture has a sand-to-ground ratio between 0.36 and 0.41, a serration index between 12% and 15%, and a porosity between 7% and 9%; and Class C architecture has a sand-to-ground ratio between 0.11 and 0.24, a serration index more than 15%, and a porosity between 3% and 6%;
wherein S2 specifically comprises the following steps:
S21, taking response parameters of troughs and peaks as a basis for identifying different sand body types; and
S22, constructing the seismic response patterns of the 3 classes of architectural unit assemblages based on the seismic response parameters of trough P2 and peak P3;
wherein the seismic response patterns of the 3 classes of architectural unit assemblages in S22 are specifically as follows: Class A is wide trough strong reflection, with a waveform P2>P3; Class B is moderate-weak trough and moderate-weak peak reflection, P2≤P3; and Class C is strong peak reflection, P2<P3;
wherein the seismic response identification standards of the 3 classes of architectural unit assemblages in S3 are as follows: Class A peak is smaller than a trough, with a strong amplitude. and a trough/peak ratio is between 1 and 2; Class B peak is larger than a trough, with a moderate amplitude, and a trough/peak ratio is between 0 and 1; and Class C peak is larger than a trough, with a strong amplitude, and a trough/peak ratio is between 0 and 1.

2. The characterization method for sand body architecture based on the amplitude properties of seismic troughs and peaks according to claim 1, wherein S1 specifically comprises the following steps:
S11, defining 7 orders of architectural interfaces in the research area based on conventional architectural interface classification solutions, characterizing internal structures of single channels under the 7 orders of architectural interfaces, and defining 6 types of 5th-order single architectural units developed within single sand bodies of a target sand unit in the research area based on the existing research understanding of sedimentary microfacies;
S12, defining the 8 types of architectural unit assemblages according to the single architectural units and vertical assemblage sequence thereof; and
S13, dividing the 8 types of architectural unit assemblages into 3 classes according to sand-to-ground ratios, serration degrees of gamma ray (GR) curves and physical properties based on geological geometric parameter ranges of different architectural unit assemblages.

3. The characterization method for sand body architecture based on the amplitude properties of seismic troughs and peaks according to claim 2, wherein the 7 orders of architectural interfaces in S11 are striate layer, micro bottom shape, moderate bottom shape, large bottom shape internal accretion body, large bottom shape, single channel and composite channel.

4. The characterization method for sand body architecture based on the amplitude properties of seismic troughs and peaks according to claim 2, wherein the vertical assemblage sequence in S12 is to identify the 5th-order single architectural units by the sand body thickness, porosity and sedimentary microfacies properties, and analyze the assemblage properties of the 5th-order single architectural units in a vertical direction; and defining a vertical assemblage sequence.

5. The characterization method for sand body architecture based on the amplitude properties of seismic troughs and peaks according to claim 2, wherein the 8 types of architectural unit assemblages in S12 are specifically: main channel sand+main channel sand, secondary channel sand+secondary channel sand, main channel sand+estuary bar sand, secondary channel sand+estuary bar sand, main channel sand+flood fan+natural dike, secondary channel sand+abandoned channel+flood fan+natural dike, estuary bar sand+secondary channel sand+abandoned channel, and secondary channel sand+abandoned channel.

6. The characterization method for sand body architecture based on the amplitude properties of seismic troughs and peaks according to claim 2, wherein S13 specifically comprises the following steps:
performing cluster analysis on geological geometric parameters of different architectural unit assemblages using the statistical package for the social sciences (SPSS), simultaneously plotting cross-plots in pairs to obtain the geological geometric parameter ranges of different architectural unit assemblages, and dividing the 8 types of architectural unit assemblages in the 3 classes according to the sand-to-ground ratios, the serration degrees of the GR curves, and physical differences.

7-10. (canceled)
